(19) United States
(12) Patent Application Publication
(10) Pub. No.: US 2005/0253732 A1
(43) Pub. Date: Nov. 17, 2005

(54) Remote controller's structure

(76) Inventor: Chzh-Lin Jao, Miao Li County (TW)

Correspondence Address: DAVID E. DOUGHERTY;Dennison, Schultz, Dougherty & MacDonald, Suite 105, 1727 King Street, Alexandria, VA, 22314-2700, US

(21) Appl. No.: 10/846,708

(22) Filed: May 17, 2004

(51) Int. Cl. G09F 13/12

(52) U.S. Cl. 340/815.55; 340/815.6

(57) ABSTRACT

An improved remote controller structure, installed by a transparent container, is fixed in the space penetrating the upper and lower outer shells. Inside the transparent container we can put in ornament in a wide variety demonstrating to increase the controller's decoration effect. Some LEDs are preferred installed at the transparent container's edge, which can let LED light emit to transparent container and create various color brightening effect in the prospect of increasing the curiosity and fantastic effort toward remote controller.

### BACKGROUND OF THE INVENTION

This invention has provided an improved structure of remote controller, specifically indicates adding a transparent container to reinforce the remote controller's decorating effect without influencing its original functions. Moreover, this invention has installed LED (Light Emitting Diode) at the edge of transparent container, making the controller available to light up the LED over the initiation of vibration or sound switch while accepting external acoustic or vibrating stimulation; and decorate the controller through LED light emitting to the transparent container.

Since the remote controller is a sort of popular, widely-applied device, which includes the tiny, portable pattern such as the vehicle's and motorcycle's remote controllers, and relatively larger one such as TV's controller, etc. Yet, the controller commodities presented in the market have paid lots of attention to perform the variance of product's outer appearance meeting customer's widely varied options. And the designs of remote controller's outer appearance in the current market are out of fashion already, making the innovative design becomes rare and most of the products are in short of curiosity and fantastic effort to satisfy customer's sense of pursuing innovation. This fact thus has become our dissatisfaction on the remote controller's application that we are familiar with.

### SUMMARY OF THE INVENTION

This invention is to provide an improved structure of remote controller by setting a penetrated space at the controller's body and installs a transparent containerl on it. Inside this container we can put various ornament in it, such as the bi-liquid ornament or others, to increase the controller's decorating effort.

The second subject of this invention that provides an improved structure to remote controller is to install one or more LEDs at the transparent container's inner edge, controlled by the vibration or sound switch inside the controller. While the controller is stimulation-initiated by external vibration or sound (such as hand clap), it will trigger the vibration/sound switch and thus the LED installed will be initiated and emit beam to the transparent container, generating colorful lighting effect to increase the curiosity and fantastic effort of remote controller.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is the first isometric scheme of embodiment on this invention.

FIG. 2 is a disassembled isometric scheme of FIG. 1.

FIG. 3 is a cross-sectional scheme of FIG. 1.

FIG. 4 is the second isometric scheme of embodiment to this invention.

FIG. 5 is the back view scheme of FIG. 4.

FIG. 6 is the third isometric scheme of embodiment to this invention.

### DETAILED DESCRIPTION OF THE PREFFERED EMBODIMENT

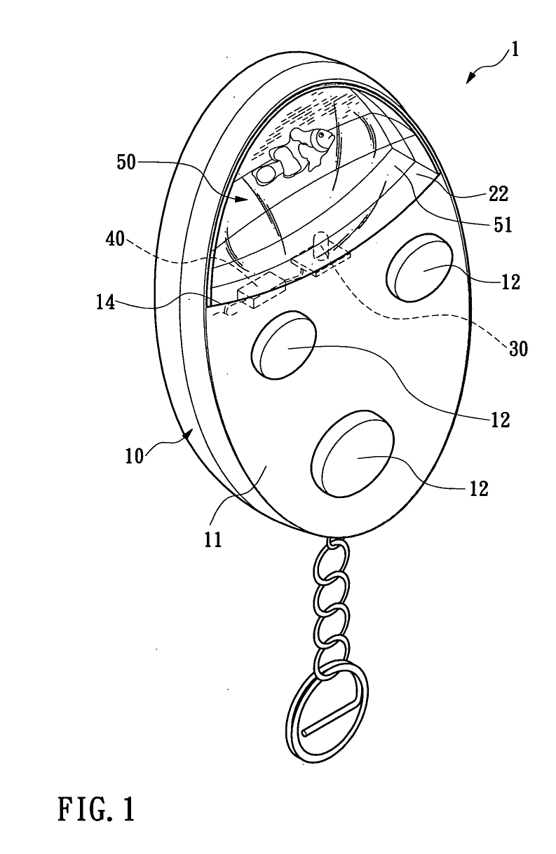

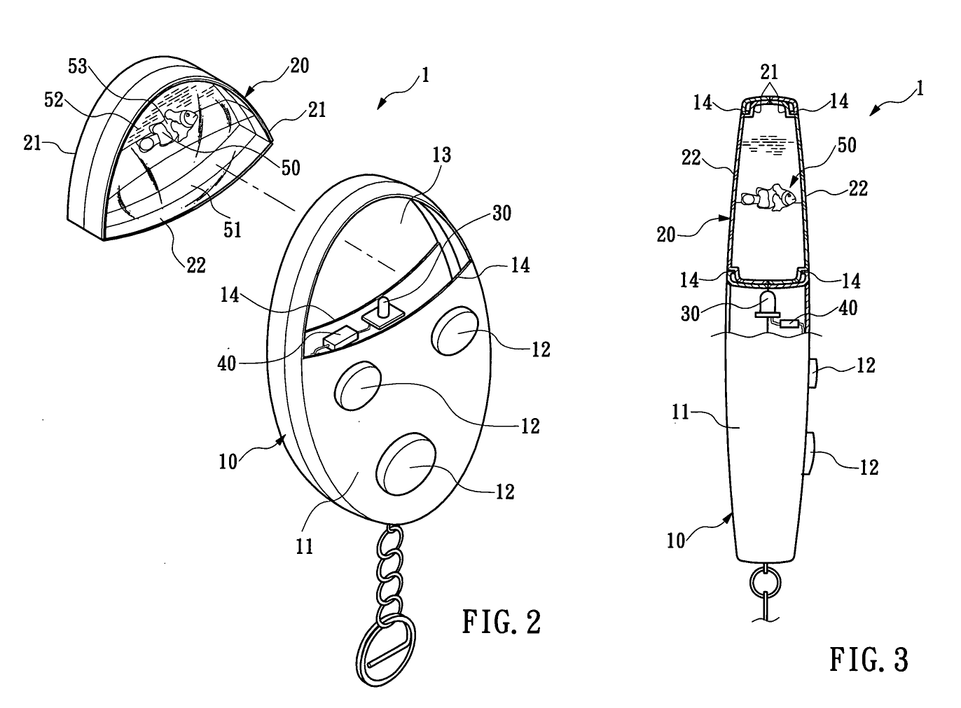

Refer to FIGS. 1, 2 and 3, the remote controller 1 is a tiny size, portable controller that is applied to the structure of vehicle, motorcycle or garage controller. This controller includes one main body 10, one transparent container 20, one or more LEDs 30 and one vibration (or sound)-controlled switch. Amid them, the main body 10 is a structure having complete controlling functions; its outer shape can be designed in a wide variety without restriction, which includes the outer shell 11 and several function controlling keys 12. Under the demand not to affect the original remote controlling functions, we can build a space 13 penetrating the upper and lower outer shells 11. The transparent container 20, closed or not closed, will be applied to install the ornaments in a wide variety. If it's a closed container, it can install bi-liquid floating object 50, shown in FIGS. 1 and 2. These two figures have displayed a lower liquid layer 51; an upper liquid layer 52 and the floating object 53 existed between the two liquid layers. And the bi-liquid floating object 50 is an ornament that can be accomplished by skilled prior art.

And the outer shape of transparent container 20 is undefined, only needed to cooperate with space 13 forming up and inserted and fixed in space 13. The setting measure is unrestricted and can be made like FIGS. 2 and 3. In the encompassed edge of transparent container 20 we have set front and back sluts 21 for stopping wedge purpose; let the outer shell 11 forms flange 14 at the edge of space 13. When assemble the composition, we can buckle the flange 14 directly to the outer side of front and back sluts 21 at transparent container 20 to simply fix the transparent container in the space 13 without slipping off. Besides, the outer surface 22 of transparent container 20 can slightly raise extending to the outer shell 11 of main body 10 to form various arc surface variation and create the image amplifying effect (while liquid is filled in), yet it's preferential not affecting controller's application or its package.

Moreover, we can install LED 30 inside the main body 10; the LED can be one or more, the color can vary under flexible selection. Each LED is preferred installed at the edge of transparent container 20, which can let LED light emit to transparent container 20 and create various color brightening effect. And we can design the LED 30 attaching to the existed power or circuit of main body 10 to simplify the design task. LED 30 is driven by vibration (or sound)-controlled switch 40 damascened inside the main body 10. The structural design method of vibration/sound controlled switches listed in the current market varies in a wide variety. While operating controller 1, it will generate certain vibration; thus if we can select vibration switch 10 having proper vibration sensibility with respect to different main body 10, basically it will generate sufficient vibration level to trigger the vibration switch 40 while main body 10 is vibrated, and make LED 30 lights up automatically at the same time. And if we replace the vibration switch 40 by sound controlled switch, we can trigger it merely by hand clapping (when we cannot find the subject remote controller 1). As for the lighting pattern of LED 30 lighting device, it can be designed in variance; such as by installing one or more LED lamps in different colors and make them light up simultaneously or intermediately in flash; or let LED stop lighting automatically after a certain lighting interval (such like 30 sec). And the vibration (or sound) switch 40 is cooperating to the application of LED, both of them can use the existed power or circuit of main body 10 making attached design. Or it can make another circuit board to reach the essential functions by currently applicable electronic skill. And the internally contained object of transparent container 20 doesn't restrict to use the bi-liquid floating object 50 shown in FIGS. 1, 2 and 3. It also can apply single transparent liquid-contained ornament or light-reflecting pieces with varying colors that can form the so-called “gold spring onion lamp” with splendid colors and light effects after being lit up by LED 30.

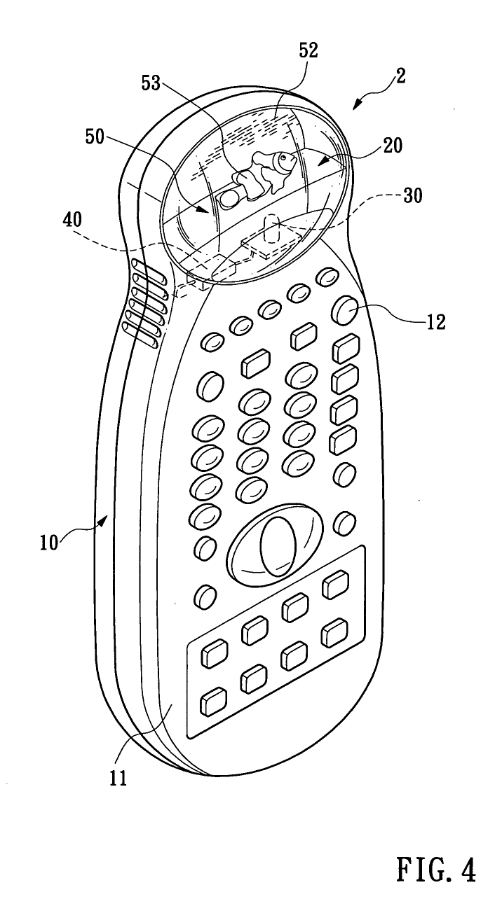

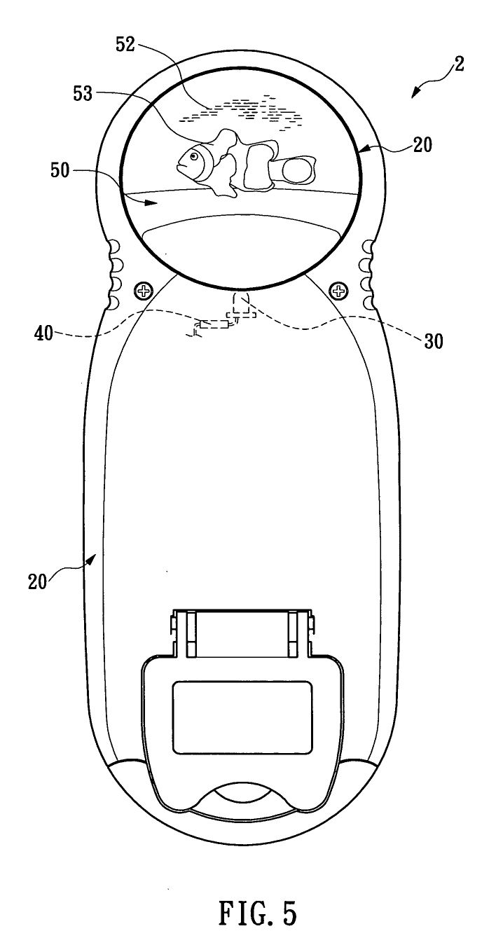

Refer to FIGS. 4 and 5; the controller 2 is another middle-size remote controller having bigger outer shell 11 and more function keys 12. Yet, the difference between controller 1 and controller 2 is nothing but the main body structure 10; and the remaining elements, including transparent container 20, the further installed LED 30 and vibration (or sound) switch 40, etc., have identical functions between controller 1 and 2.

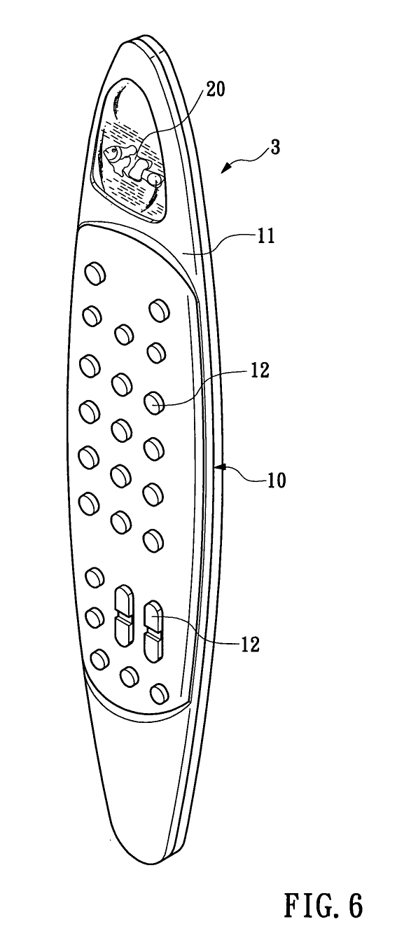

Moreover, we can refer to FIG. 6, the controller 3, which is a middle-size TV remote controller having medium size outer shell 11 and function keys 12. Yet, the difference between controller 1 and controller 3 is merely the main body structure 10. The controller still include transparent container 20, but no LED0 or vibration switch is installed in it.

1. A improved remote controller structure, provided with:
A controller's main body that is a structure with controller's full functions, which include outer shell and function keys, plus a space penetrating the upper and lower outer shells to install a transparent container on it;
A transparent container installed in the space of controller's main body that we could put various ornament into it to intensify the decoration effect of remoter controller.

2. As for the said improved remote controller structure specified in claim item 1, the transparent container can be closed or not closed type.

3. As for the said improved remote controller structure specified in claim item 2, the closed-type transparent container can contain bi-liquid floating object, which include a lower liquid layer, an upper liquid layer and the floating object existed between the two liquid layers.

4. A improved remote controller structure contains:
A controller's main body that is a structure having controller's full functions, which include outer shell and function keys, plus a space penetrating the upper and lower outer shells to install a transparent container on it;
A transparent container installed in the space of controller's main body, in which we can put ornament differently;
A vibration switch is installed inside the main body, which we can drive to “on” status by external vibration and thus will initiate LED device.
Through the structure defined above, the remote controller, when vibration initiated, will turn on the inserted LED to light up simultaneously, emitting the LED light to the transparent container and make it express a light decorating effect whenever the controller is initiated.

5. As for the said improved remote controller structure specified in claim item 4, the transparent container can be closed or not closed type.

6. As for the said improved remote controller structure specified in claim item 5, the closed-type transparent container can contain bi-liquid floating object, which include a lower liquid layer, an upper liquid layer and the floating object existed between the two liquid layers.

7. As for the said improved remote controller structure specified in claim item 4, the LED device can be one or more and the color for different LED can vary.

8. As for the said improved remote controller structure specified in claim item 4, the vibration-controlled switch can be replaced by sound-controlled switch.
